(19) United States
(12) Patent Application Publication
(10) Pub. No.: US 2007/0114341 A1
(43) Pub. Date: May 24, 2007

(54) Wrist support

(75) Inventor: William B. Raftery, Canton, OH (US)

Correspondence Address: SAND & SEBOLT, AEGIS TOWER, SUITE 1100, 4940 MUNSON STREET, NW, CANTON, OH, 44718-3615, US

(73) Assignee: RAFTERY DESIGN, INC., Canton, OH (US)

(21) Appl. No.: 11/591,236

(22) Filed: Nov. 1, 2006

Related U.S. Application Data
(60) Provisional application No. 60/739,859, filed on Nov. 23, 2005.

(51) Int. Cl. B68G 5/00

(52) U.S. Cl. 248/118

(57) ABSTRACT

A wrist support dispenser adapted to be mounted on a work surface for retaining a user's wrist and forearm in a comfortable position. The wrist support includes a body having an arcuate upper surface and is adhesively attached to a work surface to support the user's forearm and wrist when working at a desk or table. A cover plate may also be provided to secure and protect a sheet of graphics applied between the top arcuate surface and the cover plate. The cover plate is snap-fitted onto the body.

### CROSS-REFERENCE TO RELATED APPLICATIONS

This application claims priority from U.S. Provisional Patent Application No. 60/739,859, filed Nov. 23, 2005, the entire specification of which is incorporated herein by reference.

### BACKGROUND OF THE INVENTION

1. Technical Field

The present invention relates generally to office equipment. More particularly, the invention relates to wrist supports for computer users and the like. Specifically, the invention relates to a wrist support which may be retrofitted to an existing work surface, such as a table or desk.

1. Background Information

One aspect of modern life is the increasing use of computers in the home and in the office. It is common for people to spend long periods of time entering information into a computer via a keyboard and mouse or surfing the Internet looking for information. At a typical computer workstation, the keyboard is located near the front edge of the desk or other work surface and a mouse is ordinarily positioned adjacent the keyboard as an auxiliary input device to move a cursor around a computer screen. Traditionally, the user sits in front of the keyboard and mouse as the computer is utilized for work, play or for gathering general information. While a user may often use the computer for hours at a time, the user may also use the computer intermittently to perform specific tasks coming to and from the computer many times throughout the day.

The computer mouse mentioned above is a typical device used to aid the processing of information in a computer. Computer users typically use a mouse in combination with the computer keyboard. The computer mouse is normally operated on a flat work top surface that provides both the necessary space to maneuver the mouse and, in the case of a tracking ball type mouse, provides sufficient friction so that the tracking ball rotates appropriately as the mouse is navigated across the operating surface.

One of the problems associated with the use of a keyboard and mouse is the need to comfortably position the user's wrist and arm during operation. As the user positions their hands for typing on the keyboard or for utilizing the mouse, it is common that either their wrist or a portion of their forearm will land up resting on the sharp edge of the desk. Similarly, in the case of a laptop computer that incorporates a touchpad, the user's wrist or forearm will tend to rest on the edge of the computer keyboard. This causes the wrist to be held at an awkward angle and, in combination with the pressure exerted on the wrist or forearm by the edge of the desk or laptop surface, together with the extensive periods of time the computer may be used, may lead to repetitive stress injuries to the wrist and forearm such as carpal tunnel syndrome. Although it may be possible to smooth or round the edge of the desk, this normally requires significant skill and would substantially reduce the aesthetic appearance of the furniture on which the computer is placed.

Various devices have been provided in the prior art in an attempt to address this growing problem. These devices have included wrist supports that are strapped to the user's wrist and forearm, keyboard trays that incorporate a wrist rest, gel-filled or bead-filled pillows that are positioned adjacent the keyboard or mouse, and a concave arm rests that can clamp onto the edge of a desk and provide a resting place for the user's arm. A number of these previously known devices tend to shift in position relative to the keyboard or mouse over time and thereby exacerbate the problem.

While all of these devices are available on the market, existing medical and ergonomic literature does not address the kinesiology of motion in the operation of computer input devices that apply muscular skeletal forces in multiple directions and often with the result of opposing physiological forces. For example, lifting the wrist causes contraction on the top of the wrist and elongation on the underside thereof. Repetitive compound motion of the hand and the wrist of the user of a computer input device, such as a mouse, can cause muscular skeletal tension. In the case of operators of a computer mouse specifically, the index finger and associated muscles and tendons are holding the mouse button, while at the same time, the hand, thumb and other fingers are holding and causing the mouse to move. This latter motion also impacts the wrist and forearm that must twist on an axis to maintain pressure on the mouse and complete the desired action. A number of products exist, such as devices which are strapped to the user's wrist. While these strap-on wrist supports are presumably adequate for the purpose for which they are intended, they remain attached to the user during operation and should be removed if the user steps away from the computer to complete other tasks.

The need thus exists for a comfortable wrist support which will make the edge of the work surface more comfortable to the user and elevate the user's wrist to some extent in order to assist and support the user's forearm and wrist. Additionally, the need exists in the art for such a device which will remain attached to the desk so that the user may come and go from the workstation without continually removing a wrist support from the user's body or having to check on the correct orientation of the support relative to the computer keyboard or mouse.

### BRIEF SUMMARY OF THE INVENTION

The device of the present invention comprises an integral base that may be retrofit to an existing desk in order to assist in supporting the user's forearm and wrist. The base includes an arcuate upper surface and a rabbet formed into a portion thereof. An adhesive strip or other attaching device may be applied to the bottom of the rabbet to enable the unit to be attached to the edge of an existing work surface.

In an alternative embodiment, a clear cover may be positioned on top of the arcuate surface and factual information or advertising information may be positioned beneath the clear cover so that such information is readily available to the user.

### BRIEF DESCRIPTION OF THE SEVERAL VIEWS OF THE DRAWINGS

Preferred embodiments of the invention, illustrative of the best modes in which applicant contemplates applying the principles, are set forth in the following description and are shown in the drawings and are particularly and distinctly pointed out and set forth in the appended claims.

FIG. 1 is a perspective view of a workstation with the wrist support of the present invention attached thereto;

FIG. 2 is a side elevational view of the wrist support of the present invention attached to a work surface shown in section;

FIG. 3 is a perspective view of the wrist support of the present invention;

FIG. 4 is a bottom plan view of the wrist support of the present invention with a portion of the adhesive cover removed;

FIG. 5 is a cross-sectional side view of the wrist support of the present invention attached to a front edge of a work surface;

FIG. 6 is an exploded cross-sectional side view of a second embodiment of the present invention;

FIG. 7 is an assembled cross-sectional side of the second embodiment of the wrist support shown in FIG. 6;

FIG. 8 is an enlarged view of the area encircled in FIG. 7;

FIG. 9 is a top plan view of the wrist support shown in FIG. 6;

FIG. 10 is an exploded cross-sectional side of a third embodiment of the wrist support of the present invention;

FIG. 11 is an assembled cross-sectional side of the wrist support shown in FIG. 10;

FIG. 12 is a cross-sectional side view taken through line 12-12 in FIG. 11 with portions cut;

FIG. 13 is a perspective view of a fourth embodiment of wrist support of the present invention;

FIG. 14 is a cross-sectional front view of the wrist support through line 14-14 of FIG. 13;

FIG. 15 is an exploded perspective view of the wrist support of FIG. 13;

FIG. 16 is a cross-section side view of the wrist support through line 16-16 of FIG. 13;

FIG. 17 is a top plan view of a portion of a work station incorporating a fifth embodiment of wrist support in accordance with the present invention;

FIG. 18 is an exploded perspective view of the wrist support of FIG. 17;

FIG. 19 is a cross-sectional side view of the wrist support of FIG. 17; and

FIG. 20 is a side elevational view of the portion of the work station shown in FIG. 17.

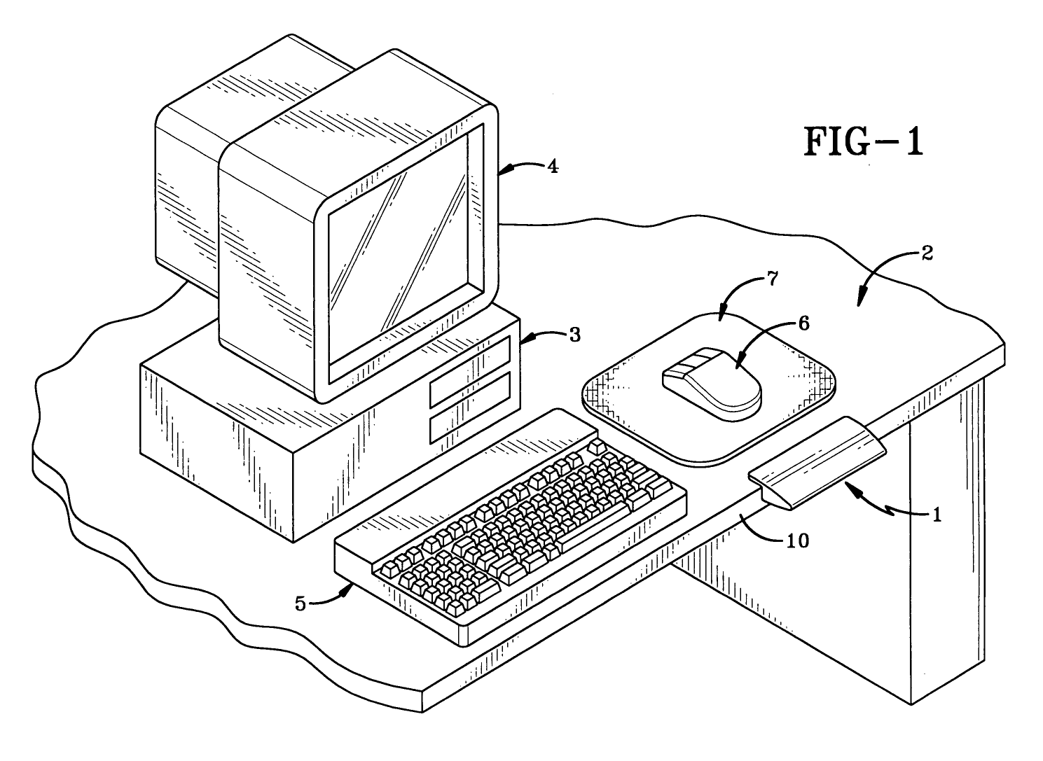

Similar numerals refer to similar parts throughout the drawings.

### DETAILED DESCRIPTION OF THE INVENTION

The improved wrist support of the present invention is indicated generally at 1, and is adapted to be mounted on a work surface 2 such as desk or table. Work surface 2 is configured to hold a computer CPU 3, a computer screen 4, a keyboard 5, a mouse 6 and a mouse pad 7. Wrist support 1 is positioned along the edge 10 of work surface 2 and outwardly from mouse pad 7 and mouse 6. This allows a portion of the user's forearm 8 and wrist 9 lie on top of wrist support 1 when operating mouse 6.

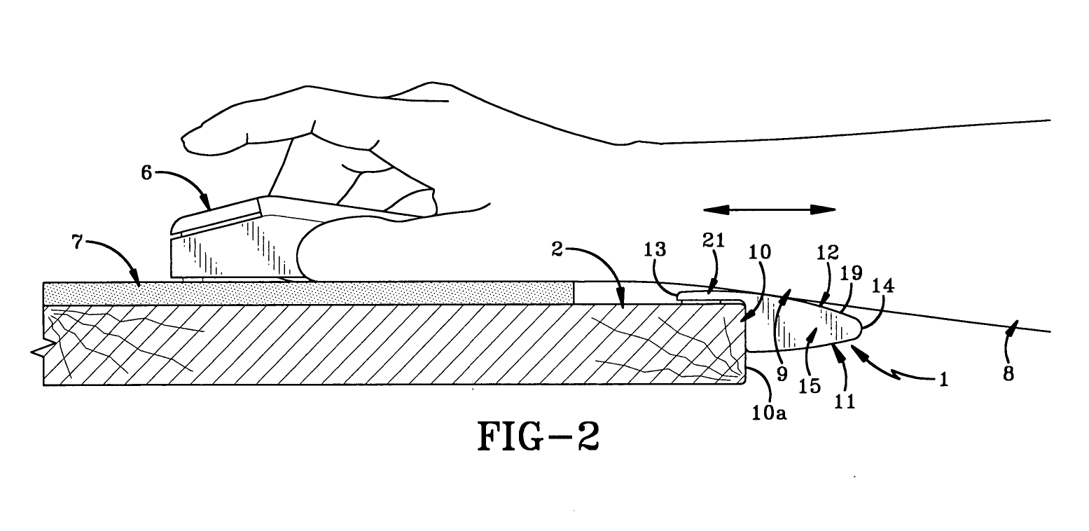

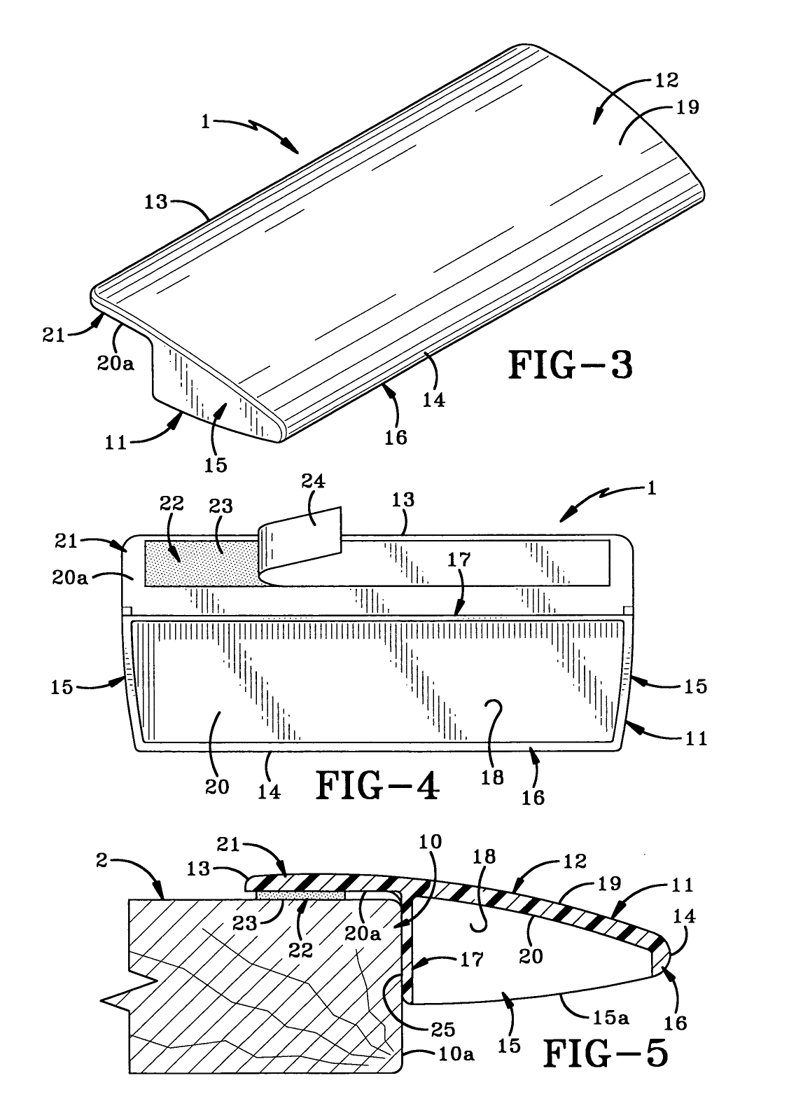

Referring specifically to FIGS. 2-5, wrist support 1 includes a body 11 having an upper wall 12, a leading edge 13 and a rear edge 14. In accordance with one of the features of the invention, upper wall 12 is arcuate and extends between leading edge 13 and rear edge 14. Body 11 is also formed with a pair of spaced apart side walls 15, a rear wall 16 and a front wall 17. Rear wall 16 and front wall 17 are substantially parallel and spaced apart and join side walls 15 to form a substantially rectangular cavity 18 beneath upperwaIl 12. Rearwall 16 is shorter than front wall 17 and consequently if wrist support 1 is placed on a flat surface, upper wall 12 arcs upwardly and outwardly away from rear wall 16. Bottom surfaces 15a of side walls 15 preferably are also arcuate and both leading edge 13 and rear edge 14 are gently rounded so that wrist support 1 does not present any sharp angles that may hurt the user.

Wrist support 1 preferably is injection molded from a suitable material such as plastic or graphite or any other material that is smooth to the touch and readily allows the user's wrist and forearm to slide thereover if need be.

Upper wall 12 includes a top surface 19 for supporting the user's wrist 9 and forearm 8 and a bottom surface 20 which extends between side walls 15, rear wall 16 and front wall 17. A portion of upper wall 12 extends outwardly beyond front wall 17 and terminates in leading edge 13. This portion of upper wall 12 constitutes a mounting flange 21. Front wall 17 extends outwardly away from bottom surface 20 of upper wall 12 in such a manner that flange 21 and front wall 17 are disposed substantially at right angles to each other. Flange 21 and front wall 17 define a rabbet 25 on the forward portion of body 11. Rabbet 25 extends substantially the entire length of body 11 and is adapted to receive a corner edge 10 of work surface 2 therein. A two-sided adhesive foam tape 22 is applied to bottom surface 20a of mounting flange 21. Adhesive tape 22 includes an adhesive portion 23 and a removable cover portion 24.

In operation, cover portion 24 of adhesive foam tape 22 is removed to expose adhesive portion 23. Body 11 is then positioned adjacent an outer corner edge 10 of work surface 2 such that front wall 17 abuts the edge 10a of work surface 2 while mounting flange 21 extends over the top portion of work surface 2 (FIG. 5). When downward pressure is applied to mounting flange 21, the adhesive portion 23 of foam tape 22 contacts work surface 2 causing wrist support 1 to be adhered thereto. In this manner, rabbet 25, defined by front wall 17 and mounting flange 21, is positioned complementary to the corner of work surface 2 so that wrist support 1 may extend in a cantilever fashion outwardly and away from the edge of work surface 2.

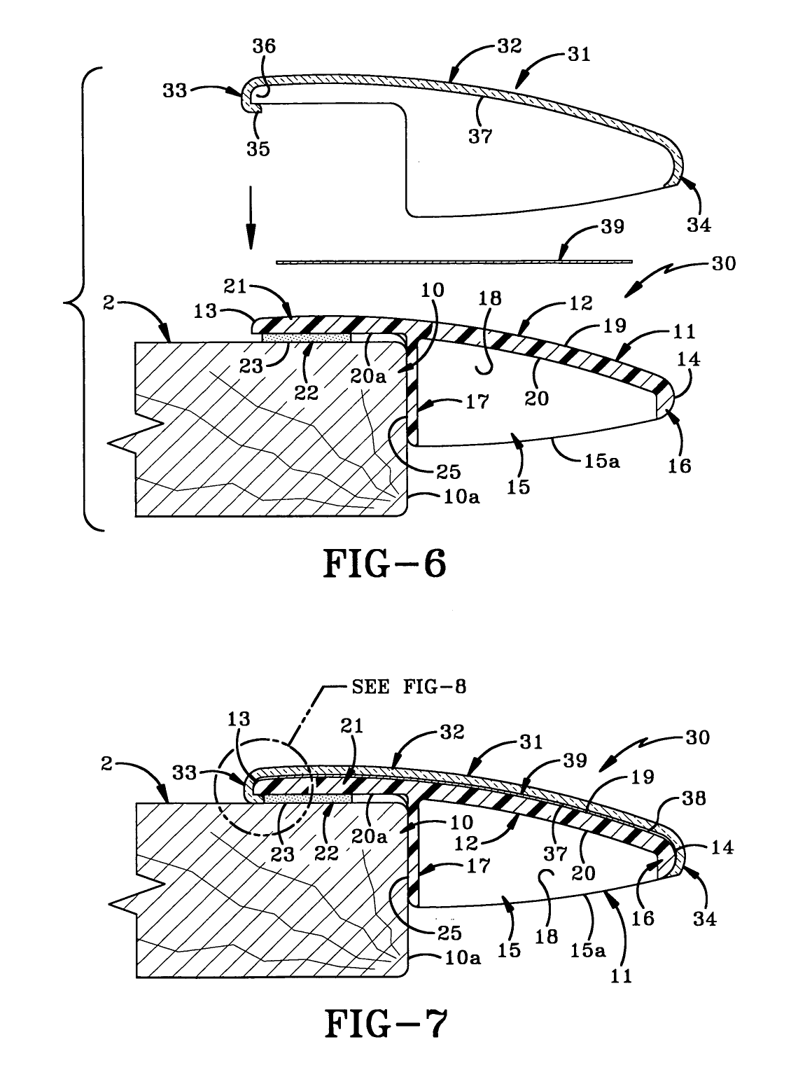

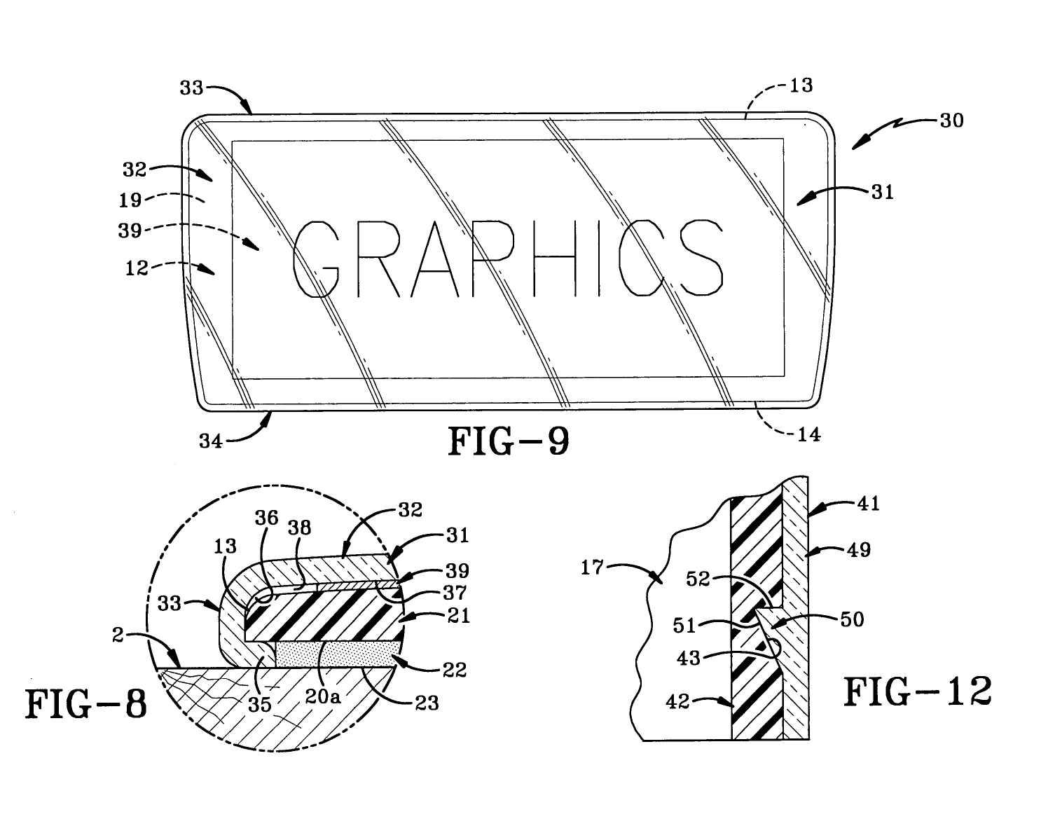

A second embodiment of the present invention is shown in FIGS. 6-9 and is indicated generally at wrist support 30. Wrist support 30 is similar to wrist support 1 as described above, with the exception that a cover plate 31 may be snap fittingly engaged over upper wall 12 of body 11. Cover plate 31 is preferably manufactured from a clear material, such as plastic, and includes an arcuately extending top wall 32 which is complementary shaped to upper wall 12 of body 11. Top wall 32 terminates at a front wall 33 and a rear wall 34. Front wall 33 has an inwardly extending flange 35 such that flange 35, front wall 33 and top wall 32 define a longitudinal cavity 36 therebetween. In accordance with one of the primary features of the second embodiment of the present invention, rear wall 34, front wall 33 and top wall 32 define a bottom surface 37 that is complementary shaped to top surface 19 of body 11 so that when cover plate 31 is installed over body 11, a relatively thin space 38 (FIG. 7) extends therebetween. Space 38 may receive a graphics sheet 39 to display useful information such as weights and measures, advertising graphics, a company logo or any other appropriate or desired information.

In operation, cover plate 31 may be installed over body 11 by positioning flange 35 beneath the leading edge 13 of mounting flange 21. In this manner, leading edge 13 of mounting flange 21 is held captive within cavity 36 and between flange 35 and bottom surface 37 of top wall 32. Graphics sheet 39 may then be positioned intermediate cover plate 31 and body 11 with cover plate 31 being flexed to move rear wall 34 of cover plate 31 around complementary shaped rear wall 16 of body 11, such that cover plate 31 is positioned on top of body 11 as shown in FIG. 7.

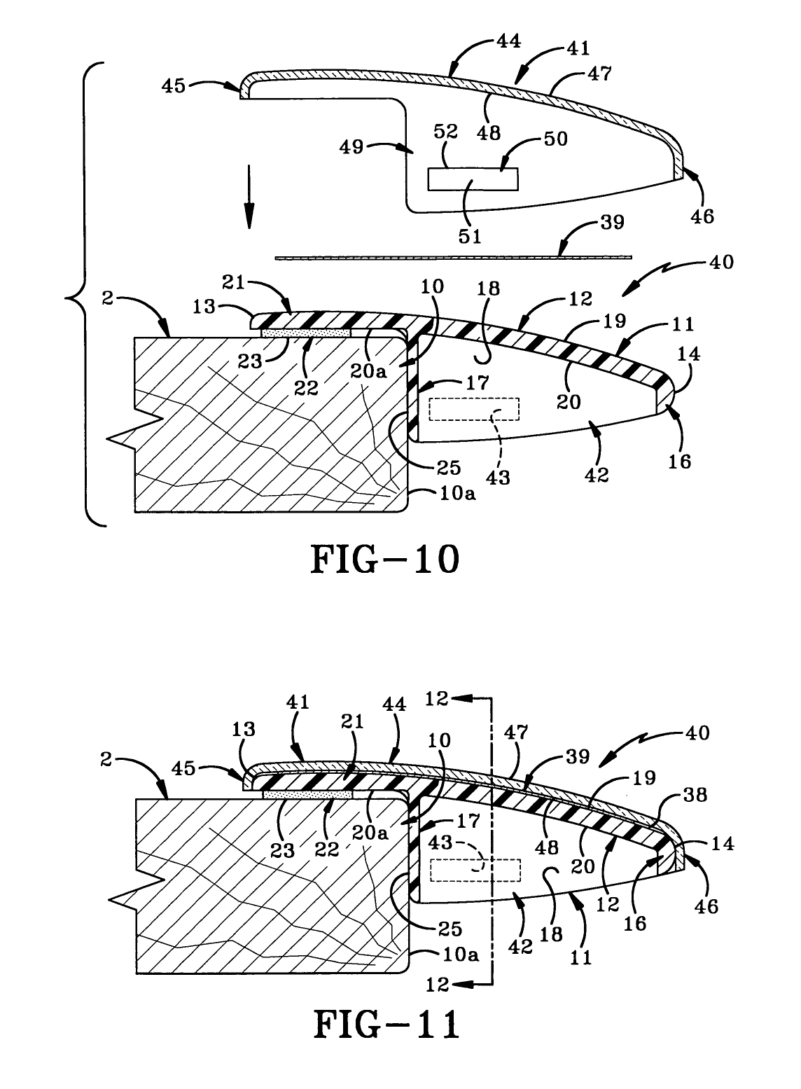

A third embodiment of the present invention is shown in FIGS. 10-12 and is indicated generally at wrist support 40. Wrist support 40 is similar to wrist support 1, except that it also includes a cover 41 which may be manufactured of any suitable material, and preferably a material that is clear. Additionally, wrist support 40 includes a pair of side walls 42 which are similar to side walls 15, except that each side wall 42 is formed with a recess 43, most particularly shown in FIG. 12. Recess 43 may be formed in any convenient location on side wall 42, but is most preferably positioned so that it will be adjacent front wall 17 and spaced from upper wall 12. Cover 41 includes an arcuately extending top wall 44 terminating at a front wall 45 and a rear wall 46. Top wall 44 is arcuately shaped in such a manner so as to support the user's hands in a position that tends to reduce stress on the wrists by maintaining them in a substantially straight and non-flexed position. Top wall 44, front wall 45 and rear wall 46 define an upper surface 47 to support the user's wrist 9 and forearm 8 and a bottom surface 48 which is complementary shaped to top surface 19 of body 11. It will be noted that no inwardly extending flange is provided at the front wall 45 of cover 41. Additionally, cover 41 includes a pair of parallel and spaced apart side walls 49 which extend downwardly from top wall 44 and are spaced to extend downwardly on either of side walls 42 when cover 41 engages body 11. Each cover side wall 49 includes an inwardly extending boss 50 which has an upwardly and inwardly extending inner wall 51 and a shoulder 52. Boss 50 is complementary shaped to interlock with recess 43 on side walls 42.

In operation, cover 41 is installed over body 11 in much the same manner as previously described with the exception that the leading edge 13 does not engage a flange on the cover. The side walls 49 of cover 41 are flexed outwardly away from each other, the cover 41 is positioned over top surface 19 of body 11 thereby trapping a graphics sheet 39 therebetween. Side walls 49 are released and cover 41 is pushed downwardly until outwardly extending bosses 50 slide downwardly along side walls 42 of wrist support 40 and into engagement with the complementary shaped recesses 43. Cover 41 is thereby secured to body 11 by these interlocking bosses 50 and recesses 43. Cover 41 may be removed by flexing side walls 49 outwardly and pulling cover 41 upwardly and away from top surface 19 of body 11.

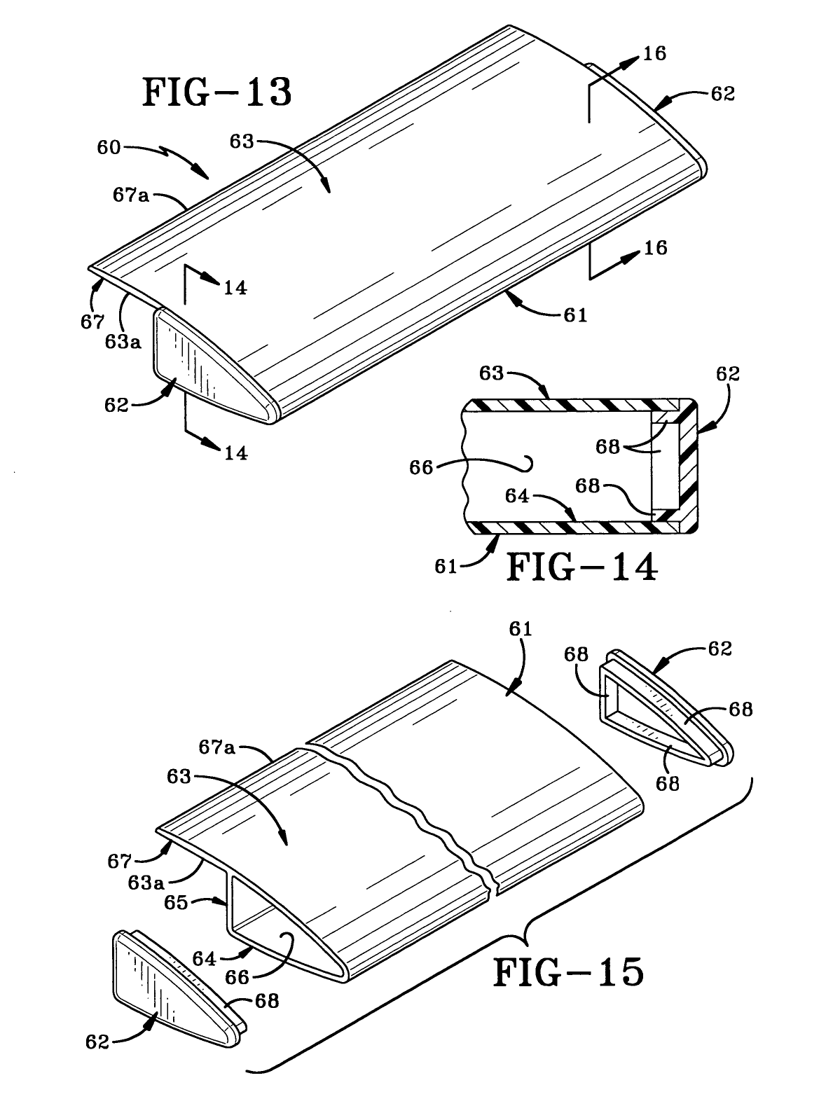

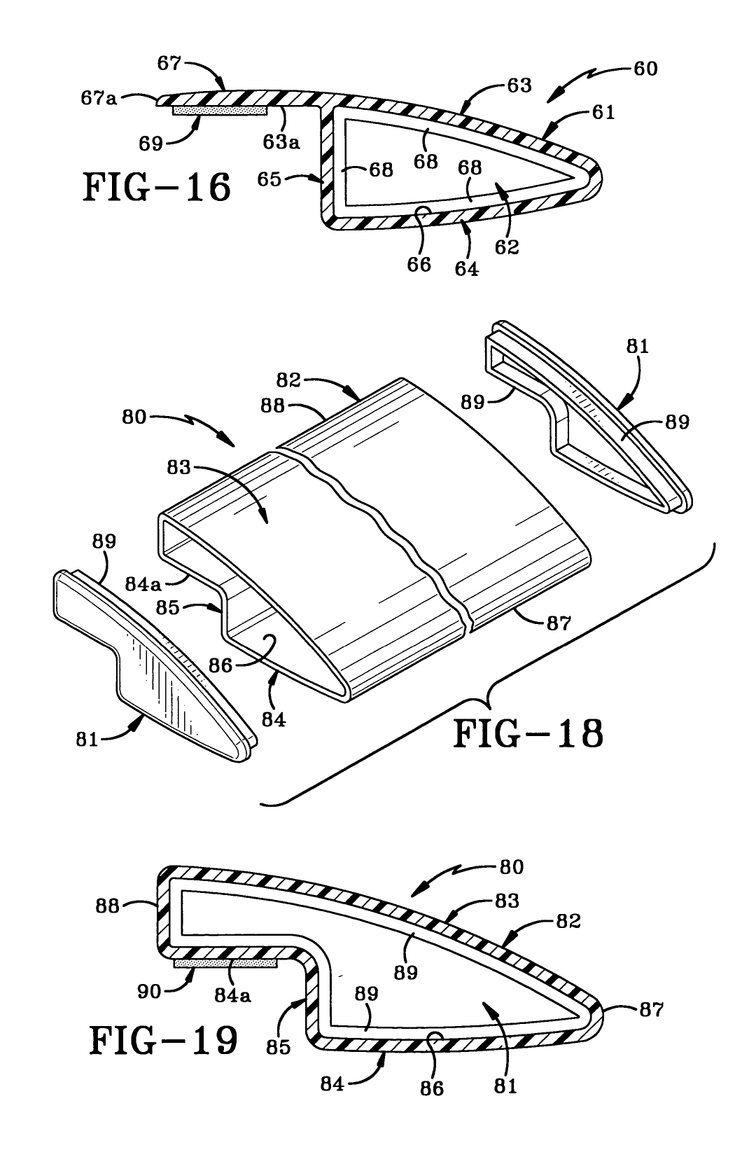

Referring to FIGS. 13-16 there is shown a fourth embodiment of wrist support in accordance with the present invention and generally indicated at 60. Wrist support 60 is similar to wrist support 1, except that the support 60 is manufactured as a frame 61 and a pair of separate side walls 62. Side walls 62 are designed to snap-fit into frame 61. Frame 61 includes a top wall 63, a bottom wall 64 and a front wall 65 which define a substantially triangularly shaped cavity 66 therebetween. A portion of top wall 63 projects outwardly beyond front wall 65 to form a flange 67 which terminates in a leading edge 67a. Side walls 62 are generally triangular in shape with gently rounded corners. Side walls 62 also include an inwardly extending peripheral lip 68 which is complementary sized and shaped to be received within cavity 66 of frame 61. Lip 68 frictionally engages the inner surfaces of the top, bottom and side walls 63, 64, 65 of frame 61. A strip of adhesive tape 69 is applied to the bottom surface 63a of flange 67. Wrist support 60 is applied to a work station in a substantially similar fashion to wrist support 1 and is used in the same manner to support the wrist 9 and forearm 8 of the user.

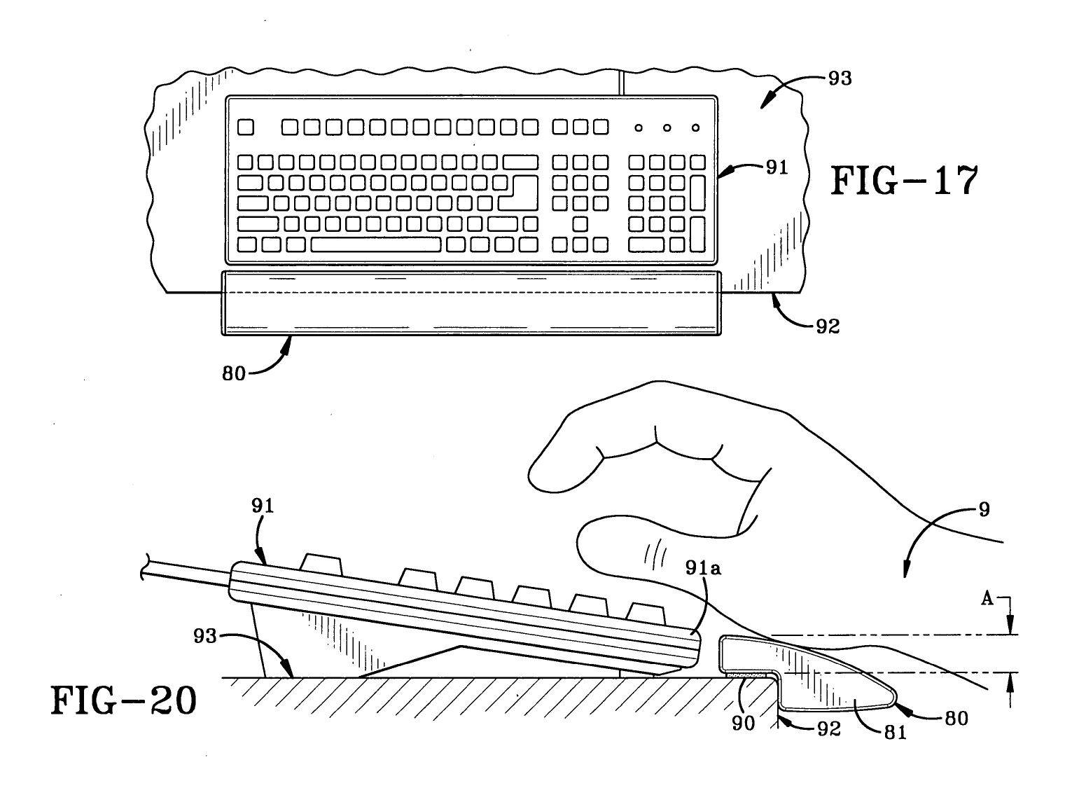

Referring to FIGS. 17-20 there is shown a fifth embodiment of wrist support in accordance with the present invention and generally indicated at 80. Wrist support 80 is substantially similar to wrist support 60 in that it includes a pair of side walls 81 which snap-fit onto a frame 82. Frame 82 includes a top wall 83, a bottom wall 84 and a front wall 85, but a portion of both the top wall 83 and bottom wall 84 extend beyond front wall 85 so that the cavity 86 formed between top and bottom wall 83, 84 extends from rear edge 87 to leading edge 88. Side walls 81 are complementary sized and shaped to attach to frame 82 and give wrist support 80 a finished appearance. Side walls 81 include a peripheral lip 89 that is complementary sized and shaped to be frictionally received within cavity 86 and engage top, bottom and front walls 83, 84, 85. A strip of adhesive tape 90 is applied to the underside 84a of that portion of bottom wall 84 that extends beyond front wall 85. As shown in FIG. 17, wrist support 80 is sized so as to be substantially the same length as a keyboard 91 and is applied to the edge 92 of a work surface 93 to support the wrist 9 of the user as they type on keyboard 91. This type of wrist support 80 could also be used in conjunction with laptop type computers that include a touch pad (not shown) for moving the cursor on the screen. FIG. 20 illustrates that wrist support 80, together with adhesive strip 90, is of a thickness “A” at its leading edge 88 that is substantially equivalent to the thickness of the front end 92 of the keyboard 91 or laptop computer (not shown). This allows the user to rest their wrist 9 and/or forearm 8 at a comfortable height for both typing and moving the cursor on a touchpad.

In summary, wrist supports 1, 30, 40, 60 and 80 each include an upwardly oriented arcuate surface to support a user's wrist 9 and/or forearm 8 as is particularly shown in FIG. 2. In this manner, the wrist 9 and forearm 8 are protected from the sharp edge of work surface 2 and provides spacing to assist in supporting the user's wrist to prevent repetitive use injuries which are common in data entry and the like. Additionally, wrist supports 30 and 40 provide a convenient way to store useful information, such as weights and measures or to provide advertising space that remains relatively permanently attached to the work surface.

As is apparent from a review of the invention, body 11 may be manufactured from any of a variety of materials, including graphite, wood, plastic and rubber, without departing from the spirit of the present invention. Furthermore, body 11 preferably is made from a substantially rigid material that maintains its shape when the wrist or forearm is resting thereon. Furthermore, the rigid material is provided with a smooth top wall that allows the user's wrist or forearm to glide thereover when their arm is moved. Similarly, cover plates 31 and 41 may also be manufactured from a variety of materials without departing from the spirit of the present invention, but a clear, transparent plastic with a smooth upper surface is preferred. Furthermore, while it has been disclosed that the wrist support of the present invention is attached to a work surface using an adhesive strip, any other suitable attachment mechanism may be utilized without departing from the spirit of the present invention. So, for example, a plurality of fasteners or a clamping mechanism may be used for this purpose. Additionally, while the adhesive strip has been disclosed as mounted on the underside of the top wall of the body, it will be understood that the strip could alternatively be applied to the surface of the front wall that is adapted to abut the edge 10 of the work surface 2. If attachment means such as screws are used, it would be preferably to insert said screws through the front wall and into the work surface. This would keep the fasteners hidden and keep the top wall free of obstacles to the user's hands as they slide thereover.

Accordingly, the improved wrist support is simplified, provides an effective, safe, inexpensive and efficient device which achieves all of the enumerated objectives, provides for eliminating difficulties encountered with prior devices, solves problems and obtains new results in the art.

It should also be noted that the wrist support of the present invention, while being designed to be secured to an edge of a work surface, may be used in a similar manner to known wrist supports by merely placing the device on the top of a work surface. The gently contoured bottom surface 15a of the side walls 15 allows the device to assume the correct angle to effectively support the user's wrist or forearm.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

Having now described the features, discoveries and principles of the invention, the manner in which the improved wrist support is constructed and used, the characteristics of the construction, and the advantages, new and useful results obtained; the new and useful structures, devices, elements, arrangements, parts and combinations, are set forth in the appended claims.

1. A wrist support for use in association with computer equipment comprising:
a body having an arcuately oriented top wall, a front wall extending downwardly from a bottom surface of said top wall and a flange extending outwardly away from one of the front wall and the top wall; whereby the front wall and flange define a rabbet adapted to accept at least a portion of a work surface therein; and an attachment device applied to the body and adapted to secure the body to a work surface.

2. The wrist support as defined in claim 1, wherein the attachment device extends at least partially into the rabbet.

3. The wrist support as defined in claim 2, wherein the rabbet formed between the front wall and the flange is substantially right angled and is adapted to receive a corner edge of the work surface therein.

4. The wrist support as defined in claim 2, wherein the flange has a bottom surface and the front wall has a front surface; and wherein the attachment device is provided on at least one of the bottom surface of the flange and the front surface of the front wall.

5. The wrist support as defined in claim 4, wherein the attachment device comprises an adhesive strip.

6. The wrist support as defined in claim 5, wherein the adhesive strip comprises a strip of adhesive foam tape having a removable non-adhesive covering positioned thereover.

7. The wrist support as defined in claim 1, further comprising:
a cover extending over at least a portion of the top wall and the flange.

8. The wrist support as defined in claim 7, wherein the cover is complementary in shape to the top wall and the flange.

9. The wrist support as defined in claim 8, wherein the cover includes an arcuately shaped upper wall having an inwardly extending front flange formed proximate a front end thereof; said front flange being disposed a spaced distance away from a bottom surface of the upper wall, whereby a cavity is formed between the bottom surface of the upper wall and the front flange.

10. The wrist support as defined in claim 9, wherein the flange on the body terminates in a leading edge and the leading edge is receivable within the cavity in the cover.

11. The wrist support as defined in claim 10, wherein the cover snap-fits over the body.

12. The wrist support as defined in claim 11, wherein the cover is manufactured from a transparent material, whereby an upper surface of one or more of the top wall and the flange on the body are visible through the cover.

13. The wrist support as defined in claim 12, wherein a space is defined between the bottom surface of the cover and the upper surface of the top wall and the flange of the body; and said space is adapted to receive a sheet of printed material therein.

14. The wrist support as defined in claim 11, wherein the body includes a pair of spaced apart side walls that extend downwardly away from the top wall and rearwardly away from the front wall, and wherein said side walls extend rearwardly toward a rear edge on said top wall.

15. The wrist support as defined in claim 14, wherein the front wall, top wall side walls and rear edge define a generally rectangular hollow cavity therebetween.

16. The wrist support as defined in claim 14, wherein the body further includes a bottom wall extending between the front wall and the rear edge of the top wall.

17. The wrist support as defined in claim 16, wherein the side walls are separate pieces of the body; each side wall including a peripheral lip that is snap fittingly received into a cavity formed between the top and bottom walls of the body.

18. The wrist support as defined in claim 17, wherein the cover further includes a pair of spaced-apart sides that extend over at least a portion of the side walls of the body.

19. The wrist support as defined in claim 18, wherein one of the sides of the cover and the side wall of the body is provided with a groove and the other of the sides of the cover and the side walls of the body is provided with a ridge; and said groove and ridge are complementary positioned and shaped to interlock with each other and thereby secure said cover and body together.

20. The wrist support as defined in claim 1, wherein the top wall of the body terminates in a rear edge and said flange on said body terminates in a leading edge; and wherein said top wall, bottom wall and flange define an interior cavity therebetween; and said interior cavity extends from said rear edge to said leading edge

21. The wrist support as defined in claim 20, further including a pair of spaced-apart side walls that extend from the rear edge to the leading edge.

22. The wrist support as defined in claim 21, wherein the side walls are integrally formed with the top wall, bottom wall and flange.

23. The wrist support as defined in claim 1, wherein said body is manufactured from a substantially rigid material.

24. The wrist support as defined in claim 23, wherein said rigid material is selected from the group consisting of graphite, wood, plastic and rubber.
